(19) United States
(12) Patent Application Publication
(10) Pub. No.: US 2013/0111532 A1
(43) Pub. Date: May 2, 2013

(54) APPARATUS AND METHODS FOR TRANSMITTING MULTI-VIEW CONTENTS

(71) Applicant: Seung-Hak Kim, Seoul (KR)

(72) Inventor: Seung-Hak Kim, Seoul (KR)

(21) Appl. No.: 13/806,292

(22) PCT Filed: Jun. 21, 2011
(86) PCT No.: PCT/KR11/04512

§ 371 Date: Jan. 15, 2013

(30) Foreign Application Priority Data
Jun. 22, 2010 (KR) 10-2010-0058905

(51) Int. Cl. H04N 21/20

(52) U.S. Cl. CPC H04N 21/20
USPC 725/105

(57) ABSTRACT

The present invention relates to a device and a method for providing multiple views for a single program in a digital cable broadcasting environment. More particularly, the device comprises a multi-view information creating means configured to create multi-view information based on a relationship between a program and a plurality of A/V (audio/video) streams when the TV program corresponds to the plurality of the A/V streams; a receiving means configured to receive the multi-view information; a reproducing means configured to reproduce a multi-view stream based on the multiplex A/V streams such that the multi-view stream contains the individual A/V streams; an examining means configured to examine a bandwidth and a program number of the multi-view stream to be transmitted by a modulator; a communication means configured to receive subscriber information through a return channel and to notify a subscriber terminal of the bandwidth and the program number for transmission of the multi-view stream selected by the subscriber; and a streaming means configured to transmit the multi-view stream containing the A/V stream corresponding to a view selected by the subscriber.

### TECHNICAL FIELD

The present invention relates to a device and a method for providing multiple views for a single program in a digital cable broadcasting environment. More particularly, the device comprises a multi-view information creating means configured to create multi-view information based on a relationship between a program and a plurality of A/V streams when the TV program corresponds to the plurality of the A/V streams; a receiving means configured to receive the multi-view information; a reproducing means configured to reproduce a multi-view stream based on the multiplex A/V streams such that the multi-view stream contains the individual A/V streams; an examining means configured to examine a bandwidth and a program number of the multi-view stream to be transmitted by a modulator; a communication means configured to receive subscriber information through a return channel and to notify a subscriber terminal of the bandwidth and the program number for transmission of the multi-view stream selected by the subscriber; and a streaming means configured to transmit the multi-view stream containing the A/V stream corresponding to a view selected by the subscriber.

A digital cable broadcast refers to a technology for transmitting digital contents using cable network which was installed before. It receives a broadcasting signal from program providers (PP), terrestrial broadcast systems, cable networks, satellites, etc., transmits the signal to the subscriber's digital terminal device, and the terminal displays the contents on the screen of the TV connected to the terminal.

Services that are provided via the digital cable broadcast include a video on demand, PPV, T-commerce, etc. besides general broadcasting services.

Digital cable provides its digital cable services in compliance with standards such as Open Cable Application Platform (OCAP) of Society of Cable Television Engineers (SCTE) in the United States and Digital Video Broadcasting (DVB) in Europe.

Digital cable broadcast comprises a head-end, a transmitting network and a local cell.

The head-end receives digital broadcasting signals from program providers (PP), terrestrial broadcast systems, cable networks, satellites, etc. and supplies the signals to the local cells.

A modulator in each cell modulates the digital signal and sends the modulated signal to a subscriber's terminal in the form of the analog signal.

A set-top box (STB) utilizes its tuner to perform processes such as tuning and demodulation onto the digital broadcast signal of each channel based on a program number and a frequency, and then displays the demodulated signal on the TV screen that is connected the terminal and performs a 1:1 interactive communication with the head-end.

### BACKGROUND ART

As TVs and terminals capable of handling digital broadcasting signals are adopted more widely among consumers, a demand for the digital cable broadcasting is rising. A digital cable broadcaster provides various interactive services using through 1:1 communication on the digital cable broadcasting network resulting in diverse expectations from the users. In a broadcasting system, services that enable a user to select an A/V stream of interest from multiple A/V streams for a same program are in a great demand. In case of sports or music programs, program providers may want a service that allows users to select an A/V stream of their interest among multiple A/V streams captured in various angles. Also, users may want to watch a specific view taken in a certain angle they prefer or in case of a music performance program of a group of singers user may want to select a specific A/V stream showing a certain singer among the group.

In a current digital broadcasting service, channels need to be allocated to each A/V stream for transmission even if multiple A/V streams are related to a same program. In this case, when a digital cable broadcaster transmits streams for the same program, each A/V stream needs to have a channel to be allocated and therefore modulators in a limited quantity cannot be effectively utilized. Also, a user would have inconveniences to remember all channel numbers for the same program and to change channels using a remote controller because the program is broadcasted in different channels.

A video on demand (VOD) service provided by the digital cable system is the service enabling users to request and watch the contents of interest at the time they want, and the service selected by the subscriber is provided in the form of MPEG-2 TS. The session established for the service is accessible only to the subscriber using the specific video on demand service. Also, the subscriber may use DVD-like functions such as fast forward (FF) and rewind (REW). However, when a normal program is broadcasted, a broadcasting session does not need to be limited only to a single subscriber because DVD-like functions may not be provided and a broadcasting schedule is predetermined. Namely, when a subscriber is watching a specific A/V stream selected by another subscriber in the same cell through a multi-view service, a broadcast service provider notifies just the information on the stream which is being transmitted without establishing another session such that a limited resource for modulators in a limited quantity can be effectively utilized in each cell.

Korean Patent No. 10-0836470 discloses a system IPTV and a method for providing a sports broadcasting service, comprising a data manager (DM) which receives sports broadcasting information; a data creating system; an EPG providing system; a multiplex system which combines data with video and audio signals captured from multiple cameras for multiplexing and sends the multiplex signals in IP packetized format; a network switch system which transmits, to the user terminal in a multicast method, the IP packetized signal received from the multiplex system; and a return channel server system which receives a camera control message from the user terminal in a unicast method.

Korean Patent Application No. 10-2009-0026617 discloses method for providing multi-angle digital broadcasting service, comprising (a) receiving a video input in a form of 3 dimensional image including stereo image taken by multiple cameras; (b) encoding the video input into a form of transmitting stream for a multi angle digital broadcasting service; and (c) transmitting the transmitting stream encoded to a terminal device.

Korean Patent Application No. 10-2008-0089327 discloses a method and an apparatus for transmitting and recording content, comprising (a) creating supplement information to be used for recording content including A/V data for multi angle; and (b) transmitting the content and the supplement information.

Despite the efforts described above, the prior arts may not respond to a service request from a subscriber considering the fact that the modulator resources are limited due to the characteristics of the digital cable network. Also, they may have drawbacks that a network resource is not efficiently used because all views for a program are to be transmitted.

The inventors of the present invention have recognized that a user can select and watch a specific view of his own interest among multiple views for a single channel program with the minimum utilization of a limited modulator resource, considering the fact that a transmitting unit for multi-view stream may transmit a broadcasting data of the view selected by a multi-view subscriber in a cable network and that a subscriber communication unit may examine whether or not the subscriber wants to use the multi-view service and may examine a selected view via the multi-view service.

### DISCLOSURE OF THE INVENTION

### Technical Problem

Therefore a purpose of the present invention is to provide a multi-view service device comprising: a multi-view information creating means configured to create multi-view information based on a relationship between a program and a plurality of A/V streams when the TV program corresponds to the plurality of the A/V streams; a receiving means configured to receive the multi-view information; a reproducing means configured to reproduce a multi-view stream based on the multiplex A/V streams such that the multi-view stream contains the individual A/V streams; an examining means configured to examine a bandwidth and a program number of the multi-view stream to be transmitted by a modulator; a communication means configured to receive subscriber information through a return channel and to notify a subscriber terminal of the bandwidth and the program number for transmission of the multi-view stream selected by the subscriber; and a streaming means configured to transmit the multi-view stream containing the A/V stream corresponding to a view selected by the subscriber.

Also, another purpose of the present invention is to provide a method for providing a multi-view service comprising: i) creating multi-view information based on a relationship between a program and multiple A/V streams when the TV program corresponds to the multiple A/V streams; ii) receiving the multi-view information; iii) reproducing a multi-view stream containing the individual A/V streams based on the multiplex A/V streams; iv) examining a bandwidth and a program number of the multi-view stream to be transmitted through a modulator; v) examining subscriber information through a return channel and notifying a terminal of the bandwidth and the program number for transmission of the multi-view stream; and vi) transmitting the multi-view service information and the multi-view stream.

### Technical Solution

The object of the present invention can be achieved by providing a device for providing a multi-view service, the device comprising: a multi-view information creating means configured to create multi-view information based on a relationship between a program and a plurality of A/V streams when the TV program corresponds to the plurality of the A/V streams; a receiving means configured to receive the multi-view information; a reproducing means configured to reproduce a multi-view stream based on the multiplex A/V streams such that the multi-view stream contains the individual A/V streams; an examining means configured to examine a bandwidth and a program number of the multi-view stream to be transmitted by a modulator; a communication means configured to receive subscriber information through a return channel and to notify a subscriber terminal of the bandwidth and the program number for transmission of the multi-view stream selected by the subscriber; and a streaming means configured to transmit the multi-view stream containing the A/V stream corresponding to a view selected by the subscriber.

As to the device, the multi-view information creating means creates the multi-view information based on a relationship between the program and the multiple A/V streams when there exists the multiple A/V streams corresponding to the single TV program.

As to the device, the receiving means receives the multi-view information created by the multi-view information creating means.

As to the device, the reproducing means reproduces the multi-view stream containing the individual A/V streams based on the multiplex A/V streams.

As to the device, the reproducing means reproduces the multi-view stream in the format of MPEG-2 SPTS containing the individual A/V streams based on MPEG-2 MPTS stream containing the multiplex A/V streams.

As to the device, the examining means examines the bandwidth and the program number of the stream for the multi-view service transmitted through the modulator by communicating with an external system which manages modulator resources on a digital cable network.

As to the device, the communication means receives the subscriber information through the return channel, and notifies the subscriber terminal, through the return channel, of the bandwidth and the program number for transmission of the multi-view stream that has been examined by the examining means.

As to the device, the streaming means transmits the multi-view stream reproduced by the reproducing means.

Another object of the present invention can be achieved by providing a method for providing a multi-view service comprising: i) creating multi-view information based on a relationship between a program and multiple A/V streams when the TV program corresponds to the multiple A/V streams; ii) receiving the multi-view information; iii) reproducing a multi-view stream containing the individual A/V streams based on the multiplex A/V streams; iv) examining a bandwidth and a program number of the multi-view stream to be transmitted through the modulator; v) examining subscriber information through a return channel and notifying a terminal of the bandwidth and the program number for transmission of the multi-view stream; and vi) transmitting the multi-view service information and the multi-view stream.

In the step i), the multi-view information is created based on a relationship between a program and multiple A/V streams when a single TV program relates to multiple A/V streams.

In the step ii), the multi-view information is received.

In the step iii), the multi-view stream is reproduced based on the multiplex streams containing the multiple A/V streams, the multi-view stream containing the individual A/V streams.

In the step iv), the bandwidth and the program number of the multi-view stream to be transmitted through the modulator is examined.

In the step v), the subscriber information is received through a return channel, and the subscriber terminal is notified, through the return channel, of the bandwidth and the program number of the multi-view stream to be transmitted.

In the step vi), the multi-view information and the multi-view stream are transmitted to the terminal.

### Advantageous Effect

As described above, according to the method of the present invention, a broadcast program provider may provide multiple A/V streams for a single channel program. A subscriber may select and watch the A/V stream that the subscriber wants among the multiple A/V streams without changing channels after the subscriber entered a certain channel.

Also, a cable broadcast may effectively increase a utilization of the limited modulator resource in a cell by transmitting just the A/V stream being watched by the subscriber.

### BRIEF DESCRIPTION OF THE DRAWINGS

The above and other features and advantages of the present invention will become more apparent by describing in detail exemplary embodiments thereof with reference to the attached drawings in which:

FIG. 1 is a service diagram illustrating a method according to the present invention;

FIG. 2 illustrates a process for reproducing MPEG-2 SPTS stream containing a single A/V stream and multi-view service information from MPEG-2 MPTS containing multiple A/V streams;

FIG. 3 illustrates a process for transmitting service streams and performing a 1:1 interactive communication with a subscriber;

FIG. 4 illustrates a process for reproducing MPEG-2 SPTS stream containing a single A/V stream from MPEG-2 MPTS containing multiple A/V streams;

FIG. 5 illustrates a process for transmitting a stream through a channel within a bandwidth, and transmitting multi-view service information through a return path, and performing a 1:1 interactive communication with a subscriber through the return path.

FIG. 6 is a flow chart illustrating an exemplary method for providing the multi-view service of the multi-view service providing device according to the embodiment of the present invention.

FIG. 7 is a flow chart illustrating an exemplary method for using the multi-view service of the subscriber terminal according to the embodiment of the present invention.

FIG. 8 is a flow chart illustrating an exemplary method for providing the subscriber with services after authentication of the subscriber when the subscriber uses the multi-view service according to the embodiment of the present invention.

FIG. 9 is a flow chart illustrating an exemplary method for examining the bandwidth and the program number for transmission of the multi-view service channel stream that has been requested by the subscriber according to the embodiment of the present invention.

FIG. 10 illustrates an exemplary method for providing a multi-view service, according to the embodiment of the present invention, through the output device connected to the subscriber terminal.

### MODE FOR INVENTION

The present invention will now be described more fully hereinafter with reference to the accompanying drawings. The present invention may, however, be embodied in many different forms and should not be construed as limited to the embodiments set forth herein.

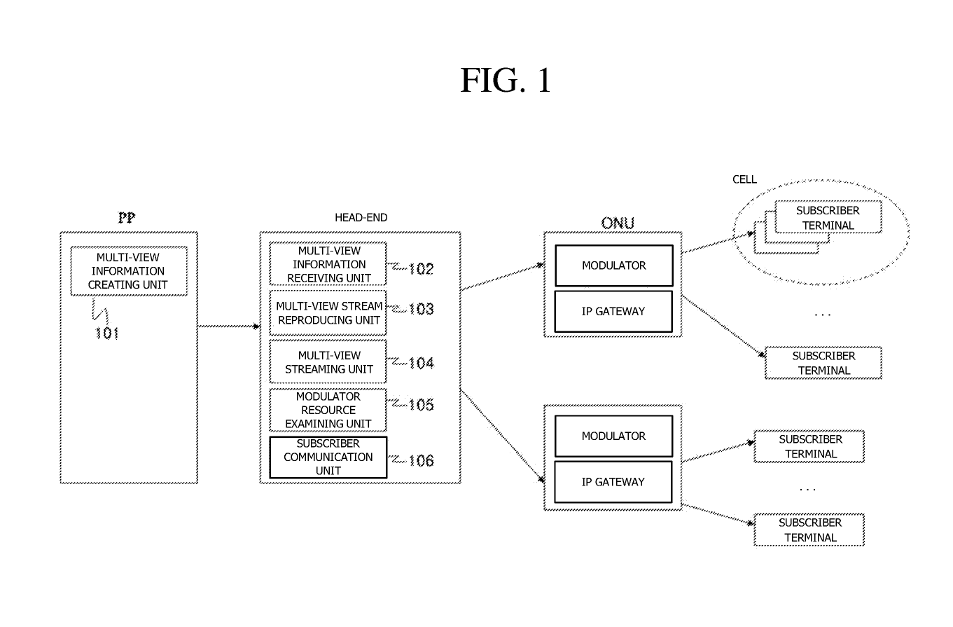

FIG. 1 is a service diagram illustrating a service system according to a method of the present invention, and the system comprises a multi-view information creating unit 101, a multi-view information receiving unit 102, a multi-view stream reproducing unit 103, a multi-view streaming unit 104, a modulator resource examining unit 105 and a subscriber communication unit 106.

The multi-view information creating unit 101 can create multi-view information.

The multi-view information receiving unit 102 can receive the multi-view information created by the multi-view information creating unit 101.

The multi-view stream reproducing unit 103 can reproduce a multi-view stream based on multiplex streams which contain a plurality of A/V streams such that the multi-view stream contains the individual A/V streams.

The multi-view streaming unit 104 can transmit the multi-view stream to the modulator.

The modulator resource examining unit 105 can examine whether or not a resource of the modulator is used, and can examine the program number and the frequency of a program transmitted through the modulator.

The subscriber communication unit 106 can receive, from the modulator resource examining unit 105, the program number and the frequency of the program transmitted through the modulator, and can command the multi-view streaming unit 104 to transmit the stream, and can perform a 1:1 interactive communication with the subscriber through the a return-path.

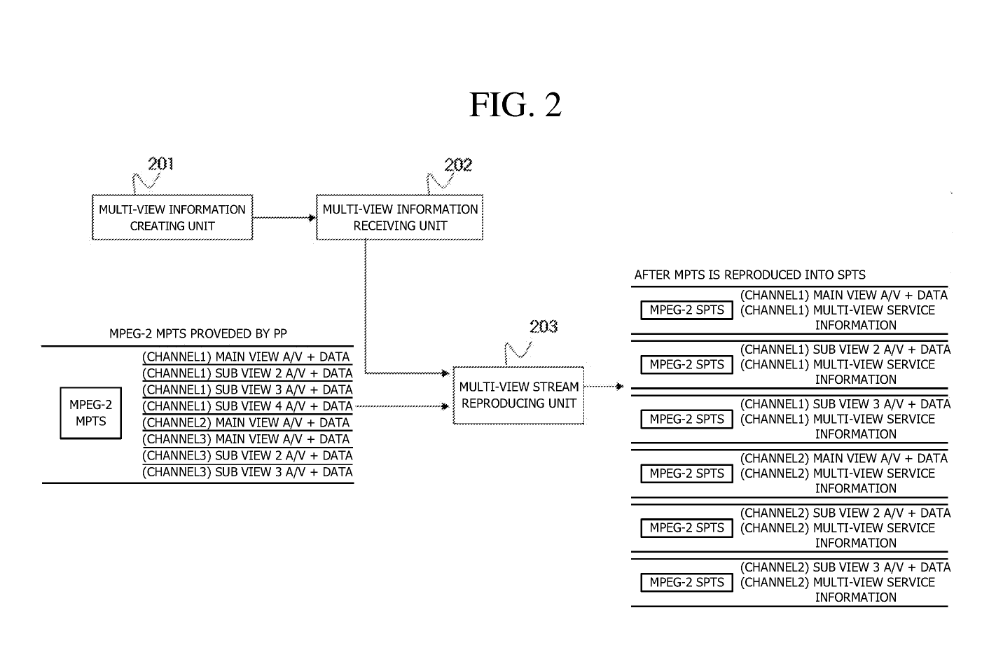

FIG. 2 illustrates a process that a multi-view stream reproducing unit 203 reproduces MPEG-2 SPTS stream for multi-view service from MPEG-2 MPTS stream including a plurality of A/V streams such that the MPEG-2 SPTS stream contains the individual A/V streams.

The multi-view stream reproducing unit 203 can reproduce MPEG-2 SPTS stream for a multi-view service by multiplexing each A/V stream included in the MPEG-2 MPTS stream—which contains the plurality of A/V streams provided by the broadcasting program provider—and the multi-view service information—which is created by the multi-view information creating unit 101 and is received by the multi-view service information receiving unit 102.

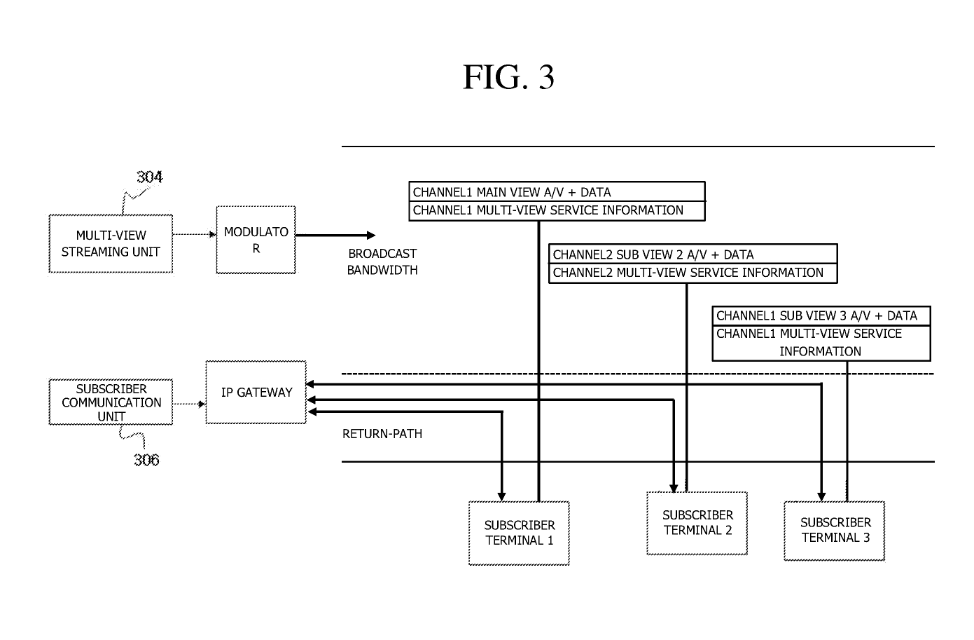

FIG. 3 illustrates that the multi-view streaming unit 304 transmits the multi-view stream and the subscriber communication unit 306 performs a 1:1 interactive communication with the subscriber.

The multi-view streaming unit 304 can transmit the MPEG-2 SPTS stream reproduced by the multi-view stream reproducing unit 203 using a broadcast bandwidth of the digital cable network through a modulator.

The subscriber communication unit 306 can perform a 1:1 interactive communication using a return-path of the digital cable network.

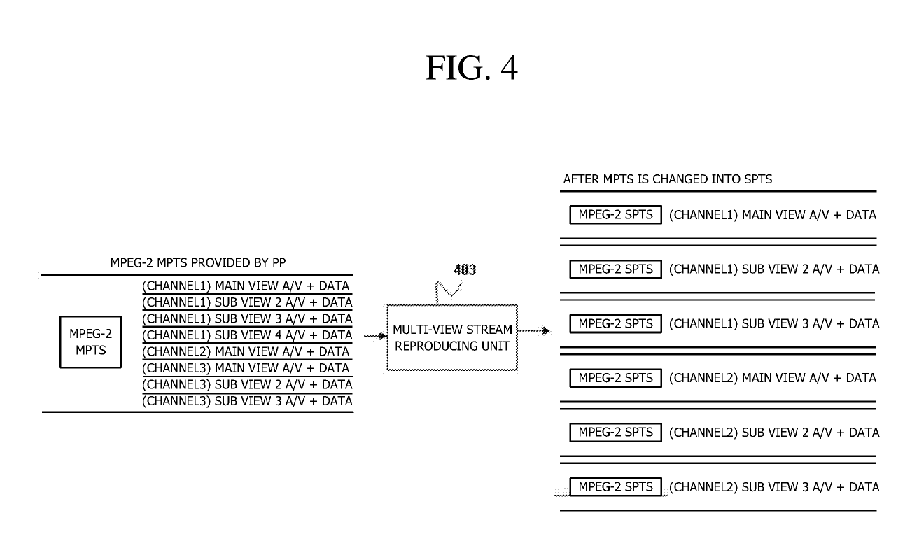

FIG. 4 illustrates that based on the MPEG-2 MPTS comprising a plurality of A/V streams provided by the broadcasting program provider, the multi-view stream reproducing unit 403 reproduces a multi-view MPEG-2 SPTS stream comprising individual A/V streams.

The multi-view stream reproducing unit 403 can create MPEG-2 SPTS stream comprising the individual A/V streams based on the MPEG-2 MPTS comprising a plurality of A/V streams provided by the broadcasting program provider.

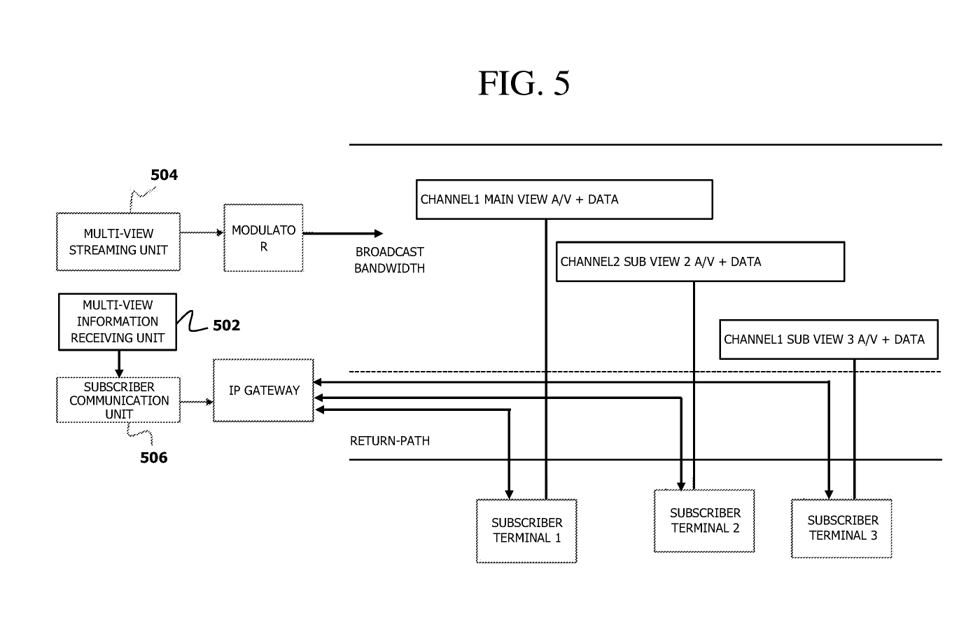

FIG. 5 illustrates that the multi-view streaming unit 504 transmits the multi-view stream and the subscriber communication unit 506 performs a 1:1 interactive communication with a subscriber.

The multi-view streaming unit 504 can transmit the MPEG-2 SPTS stream, which was reproduced by the multi-view stream reproducing unit 503, through the modulator using a channel within the bandwidth of the digital cable network.

The subscriber communication unit 506 can transmit, to the terminal through the return-path, the multi-view service information which was created by the multi-view information creating unit 101 and received by the multi-view information receiving unit 102, and can perform a 1:1 interactive communication with the subscriber terminal.

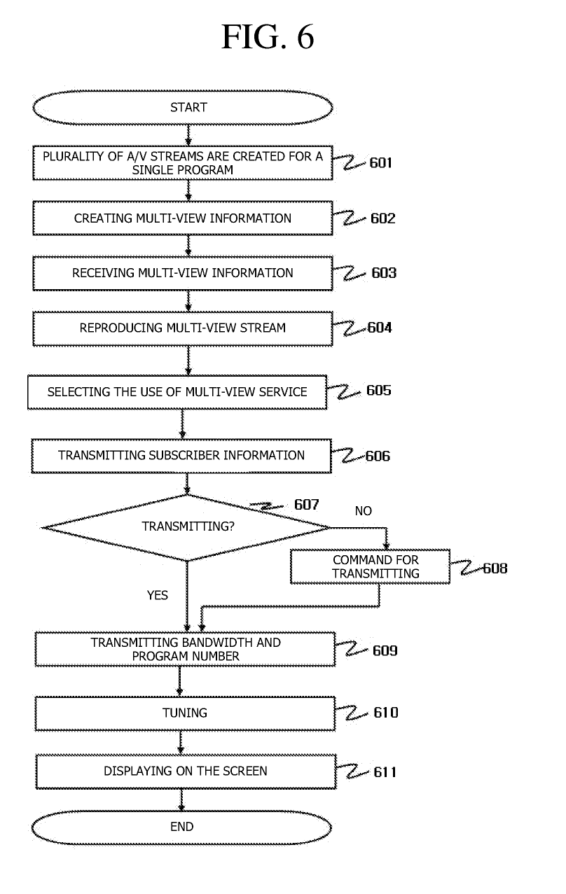

FIG. 6 is a flow chart illustrating an exemplary method for providing the multi-view service of the multi-view service providing device according to the embodiment of the present invention.

The step 601 can be a process that the broadcasting program provider creates a plurality of A/V streams for a single broadcasting program.

The step 602 can be a process that the multi-view information creating unit 101 creates the multi-view information for the multi-view service to be provided with regard to the single broadcasting program.

The step 603 can be a process that the multi-view information created by the multi-view information creating unit 101 in the step 602 is sent to the multi-view information receiving unit 102.

The step 604 can be a process that the multi-view stream is reproduced based on the multiplex streams containing the plurality of the A/V streams created by the broadcasting program provider such that the multi-view stream containing the individual A/V streams.

The step 605 can be a process that the subscriber selects a use of the multi-view service using the terminal.

The step 606 can be a process that the subscriber communication unit 106 receives the subscriber information and the multi-view service requested by performing the 1:1 interactive communication with the subscriber terminal through the return-path.

The step 607 can be a process that the modulator resource examining unit 105 examines whether or not the multi-view stream requested by the subscriber in the step 605 is already being transmitted.

The step 608 can be a process that the modulator resource examining unit 105 commands the multi-view streaming unit 104 to transmit the multi-view stream requested by the subscriber in the step 606.

The step 609 can be a process that the subscriber communication unit 106 notifies, through the return-path using the 1:1 communication, the subscriber terminal of the bandwidth and the program number for transmission of the multi-view service channel stream that has been examined by the modulator resource examining unit 105 in the step 607.

The step 610 can be a process that the subscriber terminal performs a tuning function using the bandwidth and the program number that the subscriber communication unit 106 informed in the step 609.

The step 611 can be a process that the subscriber terminal displays, on the screen, the data tuned in the step 610.

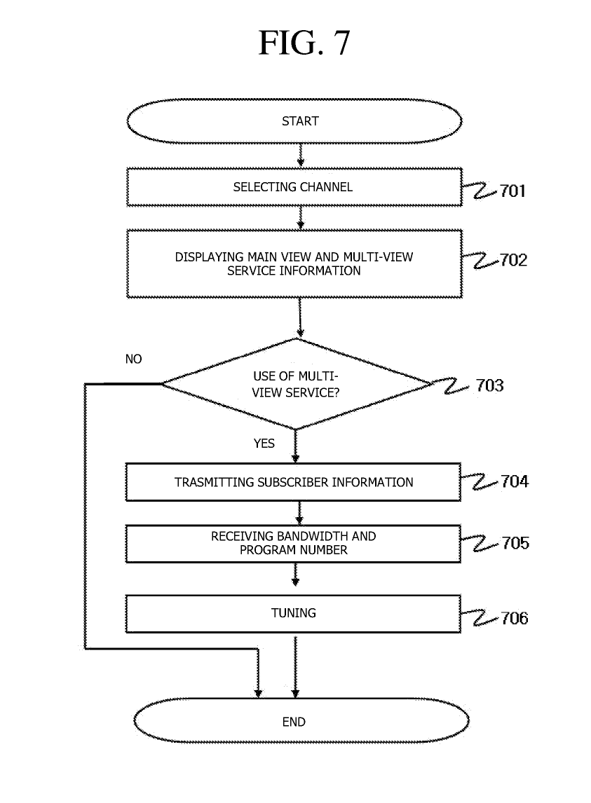

FIG. 7 is a flow chart illustrating an exemplary method for using the multi-view service of the subscriber terminal according to the embodiment of the present invention.

The step 701 can be a process that the subscriber selects a channel where the multi-view service is provided.

The step 702 can be a process that the subscriber terminal displays, on the screen, information on the A/V stream and the multi-view information of the channel selected by the subscriber in the step 701.

The step 703 can be a process that the subscriber uses the multi-view service based on the multi-view information provided in the step 702.

The step 704 can be a process that the subscriber terminal transmits the view information selected by the subscriber in the step 702 and the subscriber information through the return-path to the subscriber communication unit 106.

The step 705 can be a process that the subscriber terminal receives, from the subscriber communication unit 106, the bandwidth and the program number for transmission of the stream regarding the channel selected by the subscriber in the step 702.

The step 706 can be a process that the subscriber terminal performs a tuning of data based on the bandwidth and the program number received from the subscriber communication unit 106.

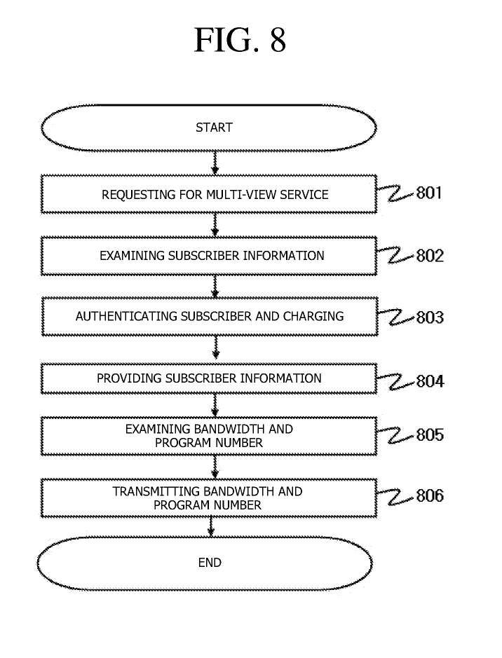

FIG. 8 is a flow chart illustrating an exemplary method for providing the subscriber with services after authentication of the subscriber when the subscriber uses the multi-view service according to the embodiment of the present invention.

The step 801 can be a process that the subscriber selects the use of the multi-view service and the subscriber terminal transmits the result of selecting to the subscriber communication unit 106.

The step 802 can be a process that the subscriber communication unit (106) examines the subscriber information of the subscriber who requested for the multi-view service in the step 801.

The step 803 can be a process that the subscriber communication unit 106 authenticates the subscriber who requested for the multi-view service in the step 801.

The step 804 can be a process that the subscriber communication unit 106 provides the modulator resource examining unit 105 with the subscriber information of the subscriber who requested for the multi-view service in the step 801.

The step 805 can be a process that the modulator resource examining unit 105 provides the subscriber communication unit 106 with the bandwidth and the program number for transmission of the multi-view stream requested by the subscriber based on the subscriber information provided by the subscriber communication unit 106 in the step 804.

The step 806 can be a process that the subscriber communication unit 106 provides the subscriber terminal with the bandwidth and the program number that the modulator resource examining unit 105 transmitted to the subscriber communication unit 106 in the step 805.

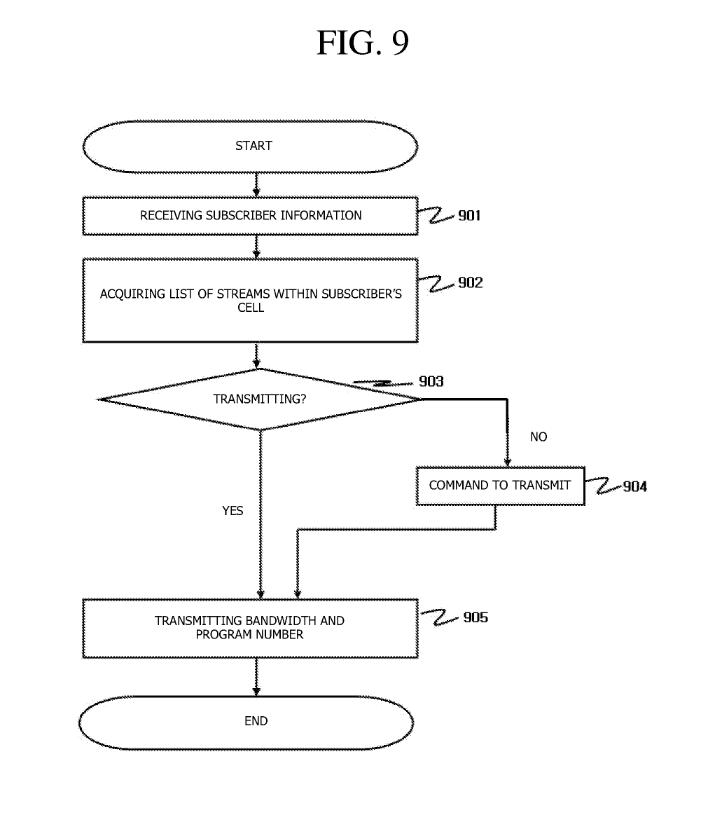

FIG. 9 is a flow chart illustrating an exemplary method for examining the bandwidth and the program number for transmission of the multi-view service channel stream that has been requested by the subscriber according to the embodiment of the present invention.

The step 901 can be a process that the modulator resource examining unit 105 receives, from the subscriber communication unit 106, the subscriber information and the stream information for the multi-view service requested by the subscriber.

The step 902 can be a process that the modulator resource examining unit 106 acquires a list of multi-view streams, transmitted by the multi-view streaming unit 104, within a cell where the subscriber is located by communicating with an external system managing the modulator resources on the digital cable network.

The step 903 can be a process that the modulator resource examining unit 106 examines whether or not the list of multi-view streams acquired in the step 902 includes the multi-view stream requested by the subscriber in the step 901.

The step 904 can be a process that the modulator resource examining unit 106 commands to transmit the multi-view service channel stream requested by the subscriber in the step 901 to the multi-view streaming unit 104.

The step 905 can be a process that the modulator resource examining unit 106 transmits, to the subscriber communication unit 106, the bandwidth and the program number for transmission of the multi-view service channel stream requested by the subscriber.

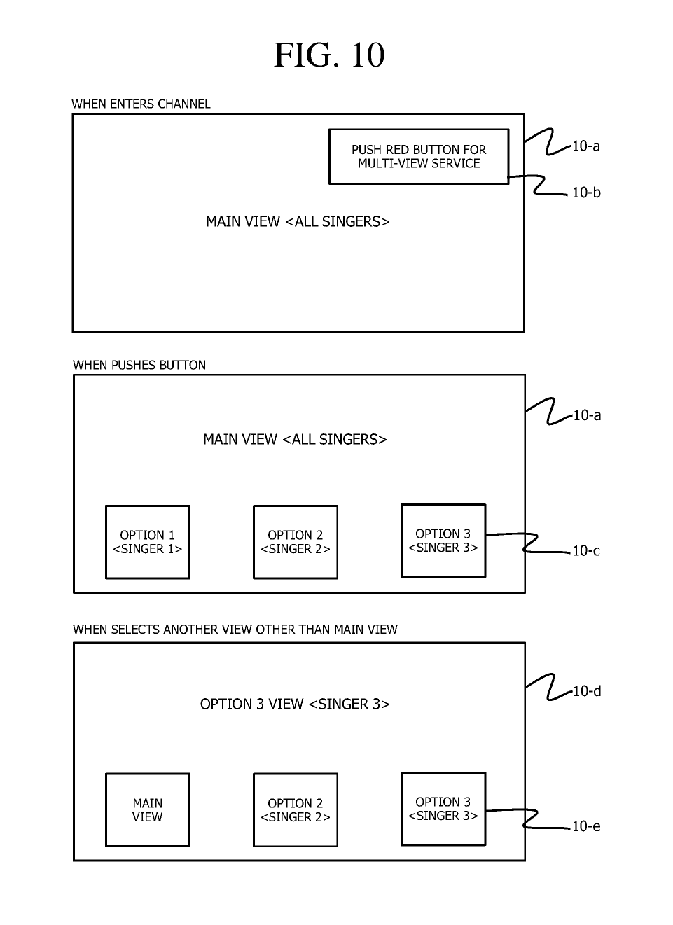

FIG. 10 illustrates an exemplary method for providing a multi-view service, according to the embodiment of the present invention, through the output device connected to the subscriber terminal.

Main view A/V contents 10-a of a program for a multi-view service are displayed on the screen when the subscriber enters a multi-view service channel.

Multi-view information 10-b is displayed on the screen when the subscriber enters the multi-view service channel.

Multi-view information 10-c is displayed on the screen when the subscriber selects a use of the multi-view service.

As to multi-view service channel sub view 10-d, when the subscriber selects another view other than the main view of the multi-view service channel, the A/V contents of the sub view are displayed on the screen.

Multi-view information 10-e is displayed on the screen when the subscriber selects another view other than the main view of the multi-view service channel.

1. A device for providing a multi-view service, the device comprising:
a multi-view information creating means configured to create multi-view information based on a relationship between a program and a plurality of A/V streams when the TV program corresponds to the plurality of the A/V streams;
a receiving means configured to receive the multi-view information;
a reproducing means configured to reproduce a multi-view stream based on the multiplex A/V streams such that the multi-view stream contains the individual A/V streams;
an examining means configured to examine a bandwidth and a program number of the multi-view stream to be transmitted by a modulator;
a communication means configured to receive subscriber information through a return channel and to notify a subscriber terminal of the bandwidth and the program number for transmission of the multi-view stream selected by the subscriber; and
a streaming means configured to transmit the multi-view stream containing the A/V stream corresponding to a view selected by the subscriber.

2. The device of claim 1, wherein the multi-view information creating means creates the multi-view information based on the relationship between the program and the multiple A/V streams when there exists the multiple A/V streams corresponding to the single TV program.

3. The device of claim 1, wherein the receiving means receives the multi-view information created by the multi-view information creating means.

4. The device of claim 1, wherein the reproducing means reproduces the multi-view stream containing the individual A/V streams based on the multiplex A/V streams.

5. The device of claim 1, wherein the reproducing means reproduces the multi-view stream in the format of MPEG-2 SPTS containing the individual A/V streams based on MPEG-2 MPTS stream containing the multiplex A/V streams.

6. The device of claim 1, wherein the examining means examines the bandwidth and the program number of the stream for the multi-view service transmitted through the modulator by communicating with an external system which manages a modulator resource of a digital cable network.

7. The device of claim 1, wherein the communication means receives the subscriber information through the return channel.

8. The device of claim 1, wherein the communication means notifies the subscriber terminal, through the return channel, of the bandwidth and the program number for transmission of the multi-view stream that has been examined by the examining means.

9. The device of claim 1, wherein the streaming means transmits the multi-view stream reproduced by the reproducing means.

10. A method for providing a multi-view service comprising:
i) creating multi-view information based on a relationship between a program and multiple A/V streams when the TV program corresponds to the multiple A/V streams;
ii) receiving the multi-view information;
iii) reproducing a multi-view stream containing the individual A/V streams based on the multiplex A/V streams;
iv) examining a bandwidth and a program number of the multi-view stream to be transmitted through a modulator;
v) examining subscriber information through a return channel and notifying a terminal of the bandwidth and the program number for transmission of the multi-view stream; and
vi) transmitting the multi-view service information and the multi-view stream.

11. The method of claim 10, wherein, in the step i), the multi-view information is created based on the relationship between a program and multiple A/V streams when a single TV program relates to multiple A/V streams.

12. The method of claim 10, wherein, in the step ii), the multi-view information is received.

13. The method of claim 10, wherein, in the step iii), the multi-view stream is reproduced based on the multiplex streams containing the multiple A/V streams, the multi-view stream containing the individual A/V streams.

14. The method of claim 10, wherein, in the step iii), the multi-view stream in the format of MPEG-SPTS containing the individual A/V streams is reproduced based on MPEG-2 MPTS stream containing the multiplex A/V streams.

15. The method of claim 10, wherein, in the step iv), the bandwidth and the program number of the multi-view stream to be transmitted through the modulator is examined.

16. The method of claim 10, wherein, in the step v), the subscriber information is received through a return channel.

17. The method of claim 10, wherein, in the step v), the subscriber terminal is notified, through the return channel, of the bandwidth and the program number of the multi-view stream to be transmitted.

18. The method of claim 10, wherein, in the step vi), the multi-view information and the multi-view stream are transmitted to the terminal.
